(19) United States
(12) Patent Application Publication
(10) Pub. No.: US 2007/0112749 A1
(43) Pub. Date: May 17, 2007

(54) Query methods and apparatuses including user profile with domain views

(75) Inventors: Derek Huang, Shanghai (CN); Alvin Wang Graylin, Bellevue, WA (US)

Correspondence Address: SCHWABE, WILLIAMSON & WYATT, P.C.;PACWEST CENTER, SUITE 1900, 1211 SW FIFTH AVENUE, PORTLAND, OR, 97204, US

(73) Assignee: mInfo, Inc.

(21) Appl. No.: 11/293,488

(22) Filed: Dec. 2, 2005

Related U.S. Application Data
(63) Continuation-in-part of application No. 11/266,912, filed on Nov. 4, 2005.

(51) Int. Cl. G06F 17/30

(52) U.S. Cl. 707/4

(57) ABSTRACT

Methods and apparatuses for processing a query are disclosed herein, including embodiments configured to generate a response to a query based at least in part on a domain view of a user profile having a number of properties, the domain view having a subset of the properties rated for a domain.

### RELATED APPLICATION

This application is a continuation-in-part of U.S. patent application Ser. No. 11/266,912, filed on Nov. 4, 2005, entitled Input/Query Method and Apparatuses, having common inventorship and claims priority to said application.

### TECHNICAL FIELD

Embodiments of the present invention relate to the field of data processing, in particular, to input/query methods for apparatuses with limited input and/or display capabilities.

### BACKGROUND

Ever since the dawn of computing, computer scientists and system designers have strived to make data more readily and/or easily accessible to end users. Over the years, database designers have developed formal database query languages, such as the Structured Query Language (SQL), to make data more readily and/or easily accessible to application developers. In turn, application developers have developed query facilities, such as Query-By-Example and natural language query for end users to input and access data directly.

With advances in microprocessor, networking, and other related technologies leading to wide spread deployment and adoption of powerful general purpose as well as special purpose portable computing and communication devices, such as wireless mobile phones, system designers are facing new challenges in making data readily and/or easily accessible. Typically, portable computing and communication devices, especially when compared to laptop and desktop computers, are more limited in input and/or display capabilities. In such environments, it's critical that users can minimize input requirements and just as important that relevant information be provided so as to maximize effectiveness of the limited screen space. Additionally, on mobile devices, the popularity of limited size message systems (short message service—SMS) as a communication medium, means that having very precise and concise responses to queries is critical to the usability of such a transport for interactive services such as mobile search.

Likewise, system designers designing controllers to control advanced special purpose digital components, such as set-top boxes, game consoles, and so forth, are also facing similar challenges. But more so on the input limitations, and less so screen limitations, although they will very often have much smaller screen resolution for displaying content when compared to standard PCs or laptops.

### BRIEF DESCRIPTION OF THE DRAWINGS

Embodiments of the present invention will be described by way of exemplary embodiments, but not limitations, illustrated in the accompanying drawings in which like references denote similar elements, and in which:

FIG. 1 illustrates an overview of the input/query methods and apparatuses of the invention, in accordance with various embodiments;

FIG. 2 illustrates query processing unit of FIG. 1 in further detail, in accordance with various embodiments;

FIG. 3 illustrates an example computer readable medium, suitable for use to facilitate practice of the present invention, in accordance with various embodiments;

FIG. 4 illustrates another embodiment of the query processing unit of FIG. 1;

FIG. 5 illustrates user profiles and domain views in further detail, in accordance with various embodiments;

FIG. 6 illustrates selected operations of the response filtering and ordering unit of FIG. 4, in accordance with various embodiments; and

FIG. 7 illustrates a system view of the input/query methods and apparatuses of the invention, in accordance with various alternate embodiments.

### DETAILED DESCRIPTION OF ILLUSTRATIVE EMBODIMENTS

Illustrative embodiments of the present invention include but are not limited to input/query methods and apparatuses, in particular, input/query methods for computing or communication devices with relatively more limited input and/or display capabilities, such as wireless mobile phones.

Various aspects of the illustrative embodiments will be described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features are omitted or simplified in order not to obscure the illustrative embodiments.

Further, various operations will be described as multiple discrete operations, in turn, in a manner that is most helpful in understanding the illustrative embodiments; however, the order of description should not be construed as to imply that these operations are necessarily order dependent. In particular, these operations need not be performed in the order of presentation.

The phrase “in one embodiment” is used repeatedly. The phrase generally does not refer to the same embodiment; however, it may. The terms “comprising,” “having,” and “including” are synonymous, unless the context dictates otherwise. The phrase “A/B” means “A or B”. The phrase “A and/or B” means “(A), (B), or (A and B)”. The phrase “at least one of A, B and C” means “(A), (B), (C), (A and B), (A and C), (B and C) or (A, B and C)”. The phrase “(A) B” means “(A B) or (B)”, that is “A” is optional.

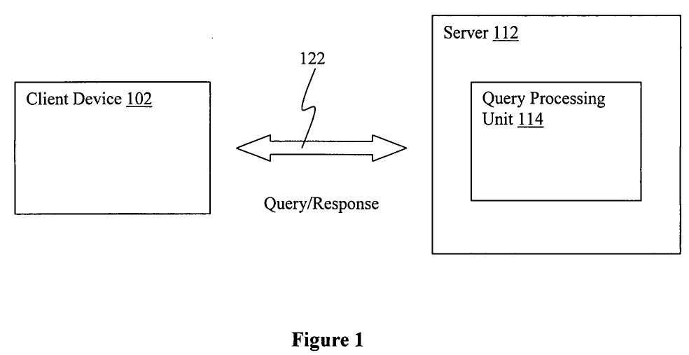

Referring now to FIG. 1, wherein a block diagram illustrating an overview of the present invention, in accordance with various embodiments, is shown. As illustrated, for the embodiments, the input/query method of the present invention enables a user to readily and/or easily access data, employing client device 102, which may be (but not limited to) relatively more limited in input and/or display capabilities. For the embodiments, client device 102 is communicatively coupled to server 112 via communication connection 122. Server 112 is configured with input/query processing unit 114 incorporated with the teachings of the present invention (hereinafter, simply “query processing unit”). As will be described in more detail below, query processing unit 114 is in particular configured to make data access from a client device 102 that may be limited in input and/or display capabilities, more user friendly. Specifically, in various embodiments, query processing unit 114 is configured to enable a user to input and submit a query expressed in a simple-natural, pseudo-natural or mixed-natural statement. Further, in various embodiments, query processing unit 114 is configured to return a more concise application or domain filtered response to the user or another user/application.

The term “simple-natural” language statement refers to a statement expressed using the words of a single language, e.g. an English statement like “Is there any French restaurant in uptown Manhattan?” formed with words of the English language, or a Chinese statement constituted with Chinese characters/words “hanzi”. The term “pseudo-natural” language statement refers to a statement having words of one language (phonetically) formed using language elements of another language (e.g. in accordance with a phonic system), such as a statement containing Chinese words phonetically formed using English alphabets in accordance with the pinyin (phonetic spelling) system, e.g. “Huangpu qu you mei you Faguo fandian” (meaning “Is there a French restaurant in HuangPu district?”) “HuangPu” is a proper name like “Manhattan”. The term “mixed-natural” language statement refers to a statement having words of one language and words of at least another language (one or more of which may be (phonetically) formed using language elements of another language (e.g. in accordance with a phonic system)), such as a statement having English words and “Chinese words” formed using English alphabets in accordance with the pinyin (phonetic spelling) system, e.g. “Is there a Faguo (French) fandian (restaurant) in HuangPu qu?” or Is there a Faguo (French) fandian (restaurant) in HP qu?” (where HP is an acronym of HuangPu). Another example of “mixed-language” is a statement with “hanzi” and pinyin (or pinyin acronym or other Romanization methods). Still another example of “mixed-language” is a statement with Chinese (hanzi or pinyin), French and English words (and optionally, one or more of these words in acronym).

Note that by allowing the various modes or types of natural language input/query, including the employment of acronyms, various embodiments are able to fully resolve and process inputs/queries expressed entirely in acronyms, e.g. “fg fd hpq” for the example of “Faguo fandian Huangpu qu”. One of ordinary skill in the art would appreciate the significant amount of keystroke savings from such an input, as well as the significant amount of reduction in output (when compared to not understanding the input/query properly).

Still referring to FIG. 1, in various embodiments, as alluded to earlier, client device 102 may be a portable communication device, such as a wireless mobile phone. In other embodiments, client device 102 may be a portable computing device, such as a personal digital assistant or smartphone. In still other embodiments, client device 102 may be both. In yet still other embodiments, client device 102 may be a (smart) controller controlling e.g. a set-top box, a game console, and so forth. Regardless, in various embodiments, client device 102 may be configured to support text messaging, enabling an input/query (in particular, one expressed in a simple-natural, pseudo-natural or mixed-natural statement) to be entered/submitted via text messaging. In various embodiments, client device 102 is configured to support the Short Messaging Service (SMS) or Multimedia Messaging Service (MMS), enabling an input/query (in particular, one expressed in a simple-natural, pseudo-natural or mixed-natural statement) to be entered/submitted via a SMS or MMS message. In still other embodiments, client device 102 may support WAP or Web based (as well as other) applications, through which the simple/pseudo/mixed-language inputs/queries may be entered and transmitted in accordance with any one of a number of communication protocols, including but not limited to HTTP, HTTPS, SMTP, SOAP and so forth. (WAP=Wireless Application Platform, HTTP=Hypertext Transmission Protocol, HTTPS=Hypertext Transmission Protocol Secure, SMTP=Simple Mail Transfer Protocol, and SOAP=Simple Object Access Protocol.)

While the present invention is particularly helpful to client device 102 with relatively more limited input and/or display capabilities, the invention is not so limited, in alternate embodiments, the invention may be practiced with client devices that are not limited in input and/or display capabilities, such as a conventional laptop and/or desktop computers.

Continuing to refer to FIG. 1, in various embodiments, server 112 may be an enterprise server, available from any one of a number of server manufacturers. In other embodiments, server 112 may be a cluster of computing devices, proximally located and coupled to each other via a local area network, or geographically dispersed, coupled to each other via a wide area network. In still other embodiments, server 112 may be a massively parallel computing system comprising of multiple processor nodes.

In various embodiments, communication connection 122 may be a “connection” over a local serial or parallel coupling. In other embodiments, communication connection 122 may be a “connection” over a local serial bus. In still other embodiments, communication connection 122 may be a “connection” over a local or wide area network, including a wide area network, that spans one or more wireless and/or wireline based voice and/or data networks.

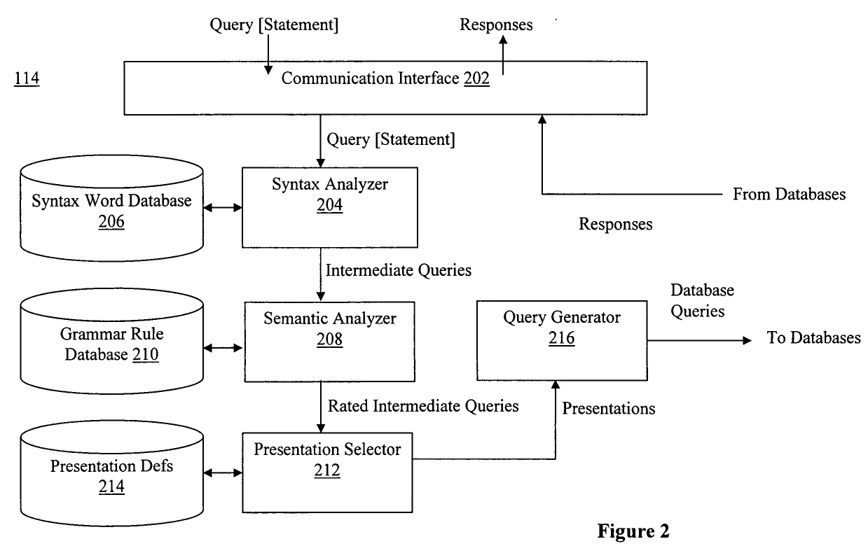

Referring now to FIG. 2, wherein query processing unit 114 of FIG. 1, in accordance with various embodiments, is illustrated in further detail. As illustrated, for one embodiment, query processing unit 114 includes communication interface 202, syntax analyzer 204, syntax word database 206, semantic analyzer 208, grammar rule database 210, presentation selector 212, presentation database 214, and query generator 216, coupled to each other as shown. In alternate embodiments, these elements may be coupled in other manners.

Communication interface 202 is configured to receive an input/query expressed in a simple-natural language, pseudo-natural language or mixed-natural language statement (hereinafter “statement”), and return a concise response to the input/query. As described earlier, in various embodiments, the response is application or domain filtered, such that the response is more user friendly for client device 102 with limited display capabilities. The terms “application” and “domain” as used herein may be generally considered synonymous, unless the context of certain specific usages clearly indicate they are not. Examples of an application or domain are “Traffic Info Application/Domain”, “Restaurant Info Application/Domain”, and so forth. Still other examples of applications or domains are: Shops/Stores, Famous sites/attractions, Stocks quotes, Ringtones, Music, Video, Games, Horoscopes, News, and so forth.

Syntax analyzer 204, coupled to communication interface 202, is configured to analyze the received statement, employing syntax words stored in syntax word database 206, to generate one or more intermediate queries. In various embodiments, each syntax word stored in syntax word database 206 comprises a simple-natural or pseudo-natural word (or its acronym), a symbol, and a type. In various embodiments, the type is domain dependent, and may map to a data variable in a data content database. For example, syntax database 206 may have the following syntax words

(a) {Faguo, FG, Country} where “Country” is the type for the symbol “FG” in a TrafficInfo Application/Domain (Faguo is the pinyin equivalent of France or French),

(b) {Faguo, FG, Cuisine} where “Cuisine” is the type for the same symbol “FG” in a Restaurant Application/Domain.

Thus, assuming syntax database 206 further includes a syntax word [HuangPu, HPQ, County], in response to the receipt of the mixed-natural language sentence “I want to know a Faguo restaurant in HuangPu district”, syntax analyzer 204 (depending on the syntax words stored in syntax database 206) may output at least two intermediate queries

1. For TrafficInfo Application: I want to know a [Faguo, FG, Country] restaurant in [HuangPu, HPQ, Region] district.

2. For RestaurantInfo Application: I want to know a [Faguo, FG, Cuisine] restaurant in [HuangPu, HPQ, Region] district.

In practice, depending on the number of applications or domains supported, syntax database 206 typically has hundreds, thousands or even hundreds of thousands of such syntax words (especially, when multitudes of acronyms are supported).

Continuing to refer to FIG. 2, semantic analyzer 208, coupled to syntax analyzer 204, is configured to analyze the intermediate queries, employing grammar rules stored in grammar database 210, to rate the intermediate queries based at least in part on how close the intermediate queries match the grammar rules, if any.

As a simplified example, continuing with the earlier exemplary mixed-natural language query, assuming semantic database 210 includes the following grammar rules

1. The rule for TrafficInfo: (‘From’)(Address+) (\w+) (County+) (\w+) (City+) (\w+) (State+) (\w+) (Country+) (w+) (‘To’) (Address+) (\w+) (County+) (\w+) (City+) (\w+) (State+) (\w+) (Country+) (\w+)

2. The rule for RestaurantInfo: (\W+) (\w+) (Series+) (\w+) (‘Restaurant’+) (\w+)(‘in’) (\w+) ((RegionName|County|City)+) (\w+)

and semantic analyzer 208 employs the following rating algorithm

Rate=NumberOfMatchedWords*1000+NumberOfMatchedCharacters+NumberOf MatchedDomainSyntax*1000,

semantic analyzer 208 would detect that the above exemplary intermediate queries match at least the above two grammar rules, and accord them a match rating of 2013 (2*1000+6+7) for the TrafficInfo Application/Domain, and 5025 (4*1000+6+10+2+7+1*1000) for the RestaurantInfo Application/Domain.

In practice, depending on the number of applications/domains supported, grammar rule database 210 typically has hundreds or even thousands of such grammar rules, especially when multitudes of pseudo and/or mixed inputs including acronyms are supported. Additionally, each field of these equations could have differing weighting to depict relevance to the overall equation, thus the real world implementations would be significantly more complicated. The examples above are purely given for illustration purpose of the general methodology.

In alternate embodiments, other approaches to rating the intermediate queries with respect to their intended application or domain may be employed.

Still referring to FIG. 2, for the embodiment, presentation selector 212, coupled to semantic analyzer 208, is configured to select one or more presentation definitions (hereinafter, simply presentations) stored in presentation database 214, based at least on the rated intermediate queries. For the embodiment, each presentation is particularized for an application/domain, including a grammar rule matching threshold and an application/domain specific database query to be generated if the grammar rule matching threshold is met or exceeded. The grammar rule matching threshold denotes the minimum matching level an intermediate query must be rated, before the associated application/domain specific database query should be generated. Accordingly, the response returned may be more concise, application or domain specific.

In various embodiments, the application/domain specific database queries may be SQL queries. In alternate embodiments, other database queries may be generated instead. In still other embodiments, the database queries need not be application/domain specific.

Referring to the earlier exemplary mixed-natural language query again, assuming presentation database 214 includes a presentation having a grammar rule matching threshold of >3000, and the associated domain specific query (i.e. Restaurant Info Application) is Select*From RestaurantInfo Where Cuisine=“ ” And Region=“ ”, since the second intermediate query matches the Restaurant Info domain grammar rule in excess of the presentation threshold of 3000, presentation selection 212 selects the Restaurant Info presentation.

Query generator 216, coupled to the presentation selector 212, is configured to generate the database query or queries of the selected presentation or presentations, and submit the generated query or queries to various data content databases. Accordingly, for the earlier exemplary mixed-natural language query, on selection of the Restaurant Info presentation, query generator 216 generates the Restaurant Info domain specific database query, e.g. Select*From RestaurantInfo Where Cuisine=“FG” And Region=“HPQ”, and submits it to one or more data content databases.

In response, the data content databases return any stored data that meet the query criteria. On receipt, communication interface 202 returns the data returned from the data content database or database(s) to the client device 102 from which the query was submitted. Accordingly, response to the client device 102 may be more particularized and concise. In alternate embodiments, the response may be (optionally) returned to another user or an application.

In various implementations, for certain applications/domains, to avoid overly particularizing and return no response to the user, each presentation may specify the generation of more than one domain specific database query. Alternatively, in various implementations, similar presentations that call for generation of slightly different database queries that potentially provide more or fewer returns may also be included in presentation database 214. Accordingly, with such presentation or presentations, additional domain specific queries, such as

1. Select*From RestaurantInfo Where Cuisine=“FG”

2. Select*From RestaurantInfo Where Region=“HPQ”

may also be generated by query generator 216, and submitted to one or more data content databases.

Additionally, in alternate embodiments, all or a subset of the data content databases queried for responses may be disposed on server 112.

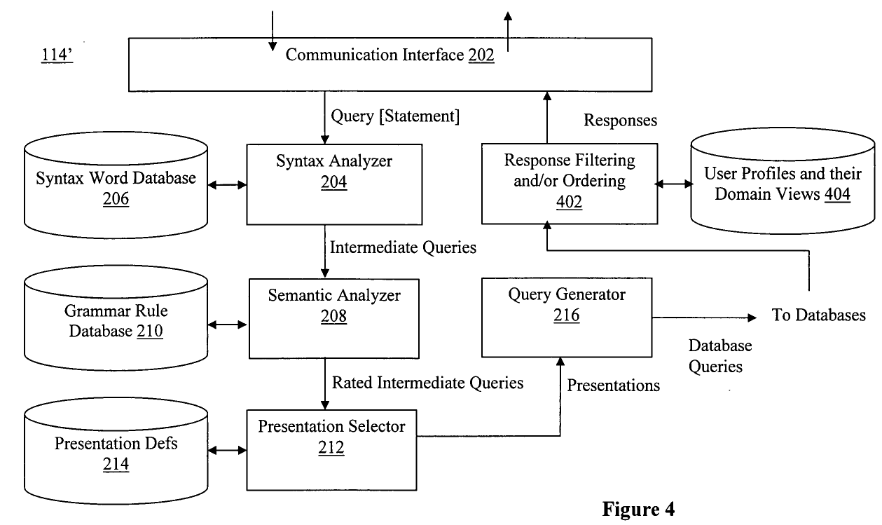

Referring now to FIG. 4, wherein an alternate embodiment of query processing unit 114′ is shown. As illustrated, for the embodiment, in addition to the elements described referencing FIG. 2, querying processing unit 114′ further includes response filtering and/or ordering unit 402 and user profile database 404, coupled to each other and the earlier described elements as shown. User profile database 404 comprises a number of user profiles and their domain views. For the embodiment, response filtering and ordering unit 402 is employed to further filter and order the answers returned from the database(s) queried, based at least in part on the domain views of the user profiles, to generate the response to be returned for a query, thereby further making the response more concise and user friendly.

In various embodiments, user profile database 404 has stored therein multiple user profiles, one for each user, e.g. a user associated with a computing or communication device, which may be an input and/or display limited device. Each of the user profiles has a number of properties, e.g. search history, preferences of merchant types or merchant price points, frequency of transactions or usage of various application types, tendencies to choose activities and/or locations of activities, value of transactions, summary scores for various commerce areas or interest areas, etc.

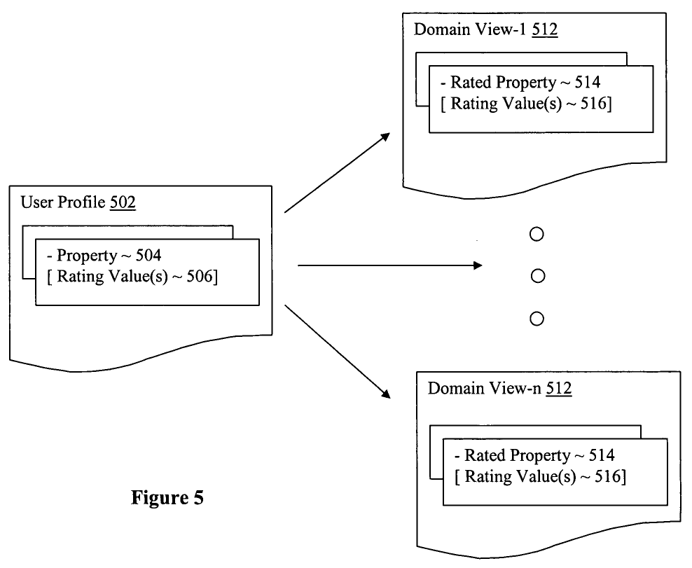

Referring now also to FIG. 5, each user profile 502 has a number of associated domain views 512, one for each domain. As described earlier, a domain may correspond to an application, such as “Traffic Info Application/Domain”, “Restaurant Info Application/Domain”, and so forth. Each of the domain views 512 includes a subset of properties 504 of the user profile. Further, for each domain view 512, the subset of properties 514 are rated for the domain. The subset of properties 514 of the various domain views 512 may be the same or different, however, typically, they are at least rated differently.

For example, a user profile may have property-1, property-2, property-3, property-4 and property-5. The user profile may have

a first domain view having property-1, property-2 and property-3 rated as most relevant, moderately relevant, and slightly relevant, respectively,

a second domain view having property-3, property-4 and property-5 rated as most relevant, moderately relevant, and slightly relevant, respectively, and

a third domain view having property-3, property-2 and property-1 rated as most relevant, moderately relevant, and slightly relevant, respectively.

The above limited example is for illustrative purpose only. In practice, typically, each user profile has significantly more properties, as well as significantly more domain views. Further, the relevancy may be denoted by quantitative values, such as 50, 40, 30, and so forth.

Continuing to refer to FIG. 5, in various embodiments, each property of a domain view 512, in addition to being rated relative to other properties of the domain view 512, may further have one or more rated values 516 of the property. When a property has more than one rated values 516 for the property, the property 514 may be referred to as fuzzy rated. For example, the early described Shopping property, in addition to being rated relative to other properties 514 of a domain view 512, may have values Shop1 having an associated rating value of 10, Shop2 having an associated rating value of 9, Shop3 having an associated rating value of 8 and so forth (denoting e.g. the user as having more interest in Shop 1, than Shop2 and Shop3. In various embodiments, each property 514 of a domain view 512 may be rated relative to other properties 514, as well as rated for different property values 516, with or without user input (e.g. by monitoring the user's behavior and/or interest). Any one of a number of machine learning techniques may be employed to perform the learning.

Accordingly, different domain views 512 having different relatively rated properties 514 and/or relatively rated property values 516 may be employed to filter and order the answers of a response for different applications, making the response more concise and user relevant for an application.

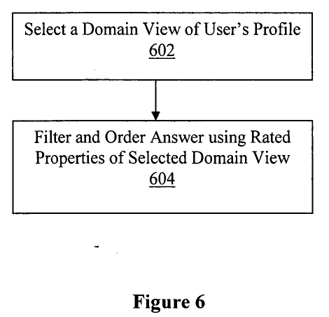

Referring now to FIG. 6, wherein a flow chart view illustrating selected operations of the response filter and order unit 402 of FIG. 4 is shown. As illustrated, for the embodiment, on invocation, response filter and order unit 402 selects a domain view of a user profile appropriate for a response, block 602. In various embodiments, the selection may be made based on user and/or domain information directly or indirectly provided with the query, and/or information gathered and/or derived by semantic analyzer 208.

In various embodiments, on selection of a domain view 512, response filter and order unit 502 sort the answers based on the rated properties 514 of the selected domain view 512 and/or their rate property values 516, block 604. The sorting may be performed using any one of a number of sorting techniques. In various embodiments, other criteria may also be employed to filter and ordered the answers to make the response more concise and relevant to the user.

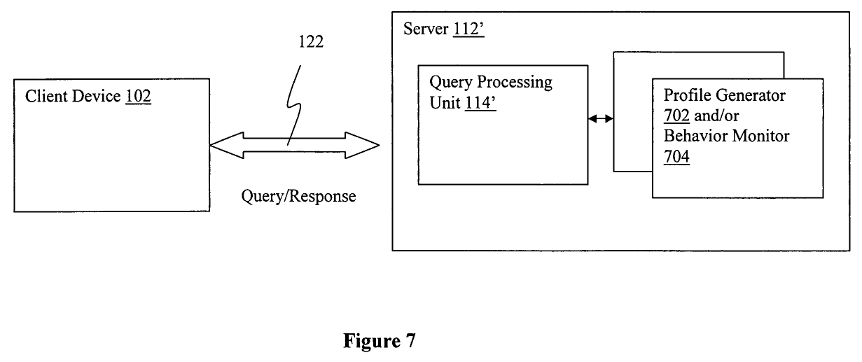

Referring now to FIG. 7, wherein a system view of the input/query method of the present invention, in accordance with various alternate embodiments is shown. As illustrated, for the embodiments, in addition to the elements described referencing FIG. 1, server 112′, in addition to querying processing unit 114′, further includes profile generator 702 and/or behavior monitor 704. In various embodiments, profile generator 702 is adapted to generate and/or update the earlier described profiles. In particular, in various embodiments, profile generator 702 is adapted to enable a user to provide inputs for the user's profile generation when the user initially registers for service, and for the user's profile update at later points in time after registration. The inputs may be facilitated employing any one of a number of input techniques.

In other embodiments, profile generator 702 may be adapted to enable auto peer-group/social network profile integration; that is, automatically associating the user with a likely relevant pre-existing profile without relying on building a user profile based on behavioral monitoring. In various embodiments, the association may be based on the user's affinity with other users and/or groups.

In various embodiments where behavior monitor 704 is provided, behavior monitor 704 may be adapted to monitor user behaviors, and profile generator 702 may be further adapted to generate and/or update the earlier described profiles, based on user behavior data collected by behavior monitor 704. The user behaviors monitored may include a wide range of such data, including but not limited to, domains queried by the user, queries submitted for the various domains, selections made in response to answers, and so forth. In various embodiment, the user behaviors monitored may be user configurable.

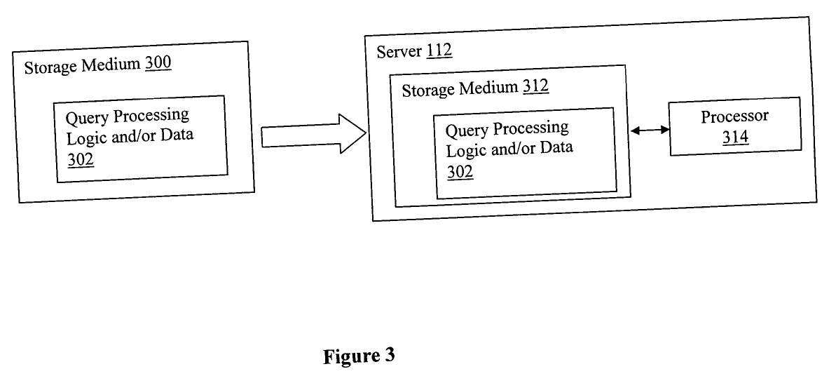

FIG. 3 illustrates an article of manufacture including a recordable/storage medium 300 readable by a computing device, in accordance with various embodiments. Recordable medium 300 has stored therein programming instructions implementing a software embodiment of the earlier described query processing unit 114 or 114′ and optionally, profile generator 702 and/or user behavior monitor 704. In various embodiments, recordable medium 300 may also include one or more of syntax database 206, grammar rule database 210, and presentation database 214.

For these embodiments, server 112 includes storage medium 302 to store at least a portion of a working copying of the programming instructions implementing the software embodiments of query processing unit 114 or 114′, profile generator 702, and/or behavior monitor 704, and at least one processor 314 coupled to storage medium 302 to execute the programming instructions. For those embodiments, where recordable medium 300 also includes one or more of syntax database 206, grammar rule database 210, and presentation database 214, storage medium 302 may also be employed to store the one or more of syntax database 206, grammar rule database 210, and presentation database 214.

Article 300 may, for example, be a diskette, a compact disk (CD), a DVD or other computer readable medium of the like. In other embodiments, article 300 may be a distribution server distributing query processing unit 114 or 114′, profile generator 702, and/or behavior monitor 704, via private and/or public networks, such as the Internet. In one embodiment, article 300 is a web server.

Although specific embodiments have been illustrated and described herein, it will be appreciated by those of ordinary skill in the art that a wide variety of alternate and/or equivalent implementations may be substituted for the specific embodiments shown and described, without departing from the scope of the present invention. This application is intended to cover any adaptations or variations of the embodiments discussed herein. Therefore, it is manifestly intended that this invention be limited only by the claims and the equivalents thereof.

What is claimed is:

1. A method comprising:
receiving a query; and
generating a response having a plurality of answers to the query ordered based at least in part on a domain view of a user profile having a plurality of properties, the domain view comprising a subset of the properties rated for a domain.

2. The method of claim 1, wherein said generating comprises first generating the answers, and then ordering the answers based at least in part on the rated properties of the domain view of the user profile.

3. The method of claim 1, wherein at least one of the properties of the user profile has a plurality of rated property values.

4. The method of claim 3, wherein the domain view comprises at least one rated property having a plurality of rated property values.

5. The method of claim 1, wherein the receiving comprises receiving the query from a portable computing or communication device, the user profile being associated with a user of the portable computing or communication device, and the method further comprises returning the response to the portable computing or communication device.

6. The method of claim 5, wherein the method further comprises receiving another query, and generating another response having another plurality of answers to the another query ordered based at least in part on another domain view of the user profile, the another domain view comprising another subset of the properties rated for another domain.

7. The method of claim 1, wherein the method further comprises receiving another query, and generating another response having another plurality of answers to the another query ordered based at least in part on another domain view of another user profile having another plurality of properties, the another domain view comprising another subset of the another plurality of properties rated for the domain.

8. The method of claim 1, wherein the receiving comprises receiving a query expressed in a simple-natural, pseudo-natural or mixed-natural language statement.

9. The method of claim 1, wherein the receiving comprises receiving a query expressed in a simple-natural language statement, the simple-natural language statement being either an English statement or a Chinese statement.

10. The method of claim 1, wherein the receiving comprises receiving a query expressed in a pseudo-natural language statement having words or acronyms of a first language phonetically formed using language elements of a second language in accordance with a phonic system.

11. The method of claim 10, wherein the first language is Chinese, the second language is English, and the phonic system is pinyin.

12. The method of claim 1, wherein the receiving comprises receiving a query expressed in a mixed-natural language statement having words of a first language, and words or acronyms of a second language phonetically formed using language elements of the first language in accordance with a phonic system.

13. The method of claim 1, wherein the domain is associated with an application selected from the group consisting of a traffic information application, a restaurant information application, a shopping information application, a famous sites/attractions information application, a news application, a stock quote application, a music application, a video application, a game application, and a ringtone application.

14. The method of claim 1, wherein the receiving comprises receiving the query in accordance with a messaging or communication protocol selected from the group consisting of short messaging service, multimedia messaging service, hypertext transmission protocol, hypertext transmission protocol secure, simple mail transfer protocol, and simple object access protocol.

15. The method of claim 1, wherein the method further comprises generating and/or updating the user profile.

16. The method of claim 15, wherein generating of a user profile comprises automatically associating the user with a sample profile based at least in part on the user's affinity with other user(s) or user group(s).

17. The method of claim 15, wherein the method further comprises monitoring for user behaviors and updating of the user profile comprises updating the user profile based on user behavior data collected for the user.

18. An apparatus comprising
an interface to receive a query; and
a query processing unit coupled to the interface, and adapted to generate a response having a plurality of answers to the query ordered based at least in part on a domain view of a user profile having a plurality of properties, the domain view comprising a subset of the properties rated for a domain.

19. The apparatus of claim 18, wherein the query processing engine is adapted to first generate the answers, and then order the answers based at least in part on the rated properties of the domain view of the user profile.

20. The apparatus of claim 18, wherein the apparatus further comprises the user profile, and at least one of the properties of the user profile has a plurality of rated property values.

21. The apparatus of claim 20, wherein the domain view comprises at least one rated property having a plurality of rated property values.

22. The apparatus of claim 18, wherein the apparatus further comprises the user profile and a plurality of domain views of the user profile for a plurality of domains, each of the domain views having a different subset of the properties of the user profile rated for a different domain, including said domain view used to generate the response.

23. The apparatus of claim 20, wherein the domains are associated with applications selected from the group consisting of a traffic information application, a restaurant information application, a shopping information application, a famous sites/attractions information application, a news application, a stock quote application, a music application, a video application, a game application, and a ringtone application.

24. The apparatus of claim 18, wherein the apparatus further comprises a user profile database having a plurality of user profiles, each user profile having a plurality of domain views, including said user profile used to generate the response and its domain views.

25. The apparatus of claim 18, wherein the interface is adapted to enable the apparatus to receive the query in accordance with a messaging or communication protocol selected from the group consisting of short messaging service, multimedia messaging service, hypertext transmission protocol, hypertext transmission protocol secure, simple mail transfer protocol, and simple object access protocol.

26. The apparatus of claim 18, wherein the query processing unit comprises one or more analyzers adapted to process the query expressed in either a pseudo-natural or mixed-natural language statement.

27. The apparatus of claim 26, wherein the pseudo-natural language statement comprises words or acronyms of a first language phonetically formed using language elements of a second language in accordance with a phonic system.

28. The apparatus of claim 26, wherein the mixed-natural language statement comprises words of a first language and words or acronyms of a second language phonetically formed using language elements of the first language in accordance with a phonic system.

29. The apparatus of claim 18, wherein the apparatus further comprises a profile generator adapted to generate and/or update the user profile.

30. The apparatus of claim 18, wherein the apparatus further comprises a behavior monitor adapted to monitor user behaviors and the profile generator is adapted to update the user profile based at least in part on behavior data of the user collected by the behavior monitor.

31. A computer readable medium comprising programming instructions configured to program an apparatus to practice the method of claim 4.

32. A computer readable medium comprising programming instructions configured to program an apparatus to practice the method of claim 1.
